(19) United States
(12) Patent Application Publication
(10) Pub. No.: US 2006/0161971 A1
(43) Pub. Date: Jul. 20, 2006

(54) Method and apparatus for providing secure connectivity between computer applications

(76) Inventor: Michael Bleahen, Rathgar (IE)

Correspondence Address: Brian L. Michaelis;Brown Rudnick Berlack Israels, LLP, One Financial Center, Boston, MA, 02111, US

(21) Appl. No.: 11/305,636

(22) Filed: Dec. 16, 2005

Related U.S. Application Data
(60) Provisional application No. 60/636,617, filed on Dec. 16, 2004.

(51) Int. Cl. H04L 9/32; H04L 9/00; G06K 9/00; G06F 17/30; G06F 15/16; G06F 7/04; G06F 7/58; G06K 19/00

(52) U.S. Cl. 726/4; 713/175; 713/156

(57) ABSTRACT

A securely configured hypertext transfer protocol (“HTTP”) server program which runs on any computer is presented. The program includes an application on the client-side of an eCommerce transaction that allows secure connectivity between applications running on the same computer and between applications running on different computers. The program additionally provides for secure connectivity between computer applications providing a variety of functionalities including generation of digital certificates, user authentication, remote application connectivity, document collaboration, software installation and remote assistance capability.

### CROSS REFERENCE TO RELATED APPLICATIONS

This application claims the benefit U.S. Provisional application Ser. No. 60/636,617 entitled “Method and Apparatus for Providing Secure Connectivity between Computer Applications Irrespective of Whether the Applications Reside on the Same Computer or the Applications Reside on Different Computers” filed on Dec. 16, 2004, which application is incorporated by reference herein.

### FIELD OF INVENTION

The present invention relates to computer applications, more specifically, to providing secure connectivity between computer applications.

### BACKGROUND OF INVENTION

Web browsers such as Internet Explorer and Mozilla are the main interfaces to the World Wide Web. In recent years, with the advancement of information technology, the World Wide Web has become an important gateway in the world of entertainment, business, media, etc. The web browsers themselves only function to display downloaded web pages or provide the ability to fill forms. Apart from being able to upload a document, web pages do not provide any means for the computer on to which the web page is downloaded to interact with the server that provided the web page. Previously, software manufacturers used a set of technologies that enable interactive content through the World Wide Web. Using mark-up languages such as hypertext transfer mark-up language (“HTML”) and extensible mark-up language (“XML”) in conjunction with applications such as JAVA Applets, and ActiveX objects provides limited ability for remote applications to interact. The use of HTML alone provides only display functionality. The use of these tools by software developers to enhance the content provided over the web requires the user to download and install an Applet/ActiveX component. Applet/ActiveX objects are pieces of functional software downloaded to the user's web browser. Installing and using these “plug-ins” creates security risks making the user's computer vulnerable. Applets and ActiveX objects can contain viruses and other nefarious functional code. The inherent security risks with such applications have lead to their phase-out in recent years. As a consequence of the dwindling use of these tools, the lack of web-page functionality and the lack of a secure mechanism to enhance the connectivity and user interaction, the web page downloaded to a user's computer is the end-point in internet transactions.

### SUMMARY OF THE INVENTION

The present invention provides for a securely configured hypertext transfer protocol (“HTTP”) server program which runs on virtually any computer. An embodiment of the present invention includes an application on the client-side of an eCommerce transaction that allows secure connectivity between applications running on the same computer and between applications running on different computers.

The present invention provides for secure connectivity between computer applications providing a variety of functionalities. An embodiment of the present invention generates digital certificates as well as implements a Public Key Infrastructure (“PKI”) Authentication without compromising the secure user's passkey or password. The server, in one embodiment provides remote application connectivity methods for data transfer between a client and a server in both a PKI secure transaction and a non-PKI transfer. An embodiment of the present invention provides for a non-functional transfer file, a data file containing secure information, to be created either by the local application or by the user. The present invention also provides for secure methods of document collaboration, software installation and remote assistance.

The inventive program utilizes a set of processes which are executed in response to commands contained in a transmitted file. Only processes which are signed by the server are allowed. Thus the list of processes is extendable, however only the server can extend the list. Merchants cannot, nor can any other unauthorized user, extend the list of processes which the inventive program can execute, thus ensuring the security of a program.

Secure connectivity between applications can be derived from two sources: the HTTP nature of the server, which only allows GET and POST operations, and the use of digital certificates. One advantage of the present invention is that it allows for a single certificate environment. Clients do not need to use a different certificate in each “Business-to-Business” (“B2B”) application.

In an embodiment of the present invention, a standalone server is implemented. The server can run on any computer, however the server operates as a client-side application rather than a server-side application. The server never connects to the web itself, but instead uses non-functional web pages downloaded into a client's browser to move data to or accept data from the web. An embodiment of the present invention includes a security measure in which the server maintains an IP address of ‘127.0.0.1’ or ‘localhost’ and thus can only ever be accessed via a browser running on the same computer. Additionally, when a computer connects to the web it is given an IP address, either permanent or temporary. If a user attempts to connect to the program on this IP address rather than ‘127.0.0.1’ or ‘localhost’, then that connection is refused. An embodiment of the present invention uses pages downloaded to the client's browser and works as a relay between the computer on which the program is installed and a remote computer.

### DESCRIPTION OF DRAWINGS

The foregoing and other features and advantages of the present invention will be more fully understood from the following detailed description of illustrative embodiments, taken in conjunction with the accompanying drawings in which:

FIG. 1 is a flow diagram of the GET instruction in accordance with an embodiment of the present invention;

FIG. 2 is a flow diagram of the POST instruction in accordance with an embodiment of the present invention;

FIG. 3 is a flow diagram of a digital certificate generation process in accordance with an embodiment of the present invention;

FIG. 4 is a flow diagram of an authentication process in accordance with an embodiment of the present invention;

FIG. 5 is a flow diagram of a remote application connectivity process in accordance with an embodiment of the present invention;

FIG. 6 is a flow diagram of a remote application connectivity process in accordance with an embodiment of the present invention;

FIG. 7 is a flow diagram of a document collaboration process in accordance with an embodiment of the present invention;

FIG. 8 is a flow diagram of a software installation process in accordance with an embodiment of the present invention; and

FIG. 9 is a flow diagram of a remote assistance process in accordance with an embodiment of the present invention.

### DETAILED DESCRIPTION

Detailed embodiments of the present invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the present invention in virtually any appropriately detailed embodiment.

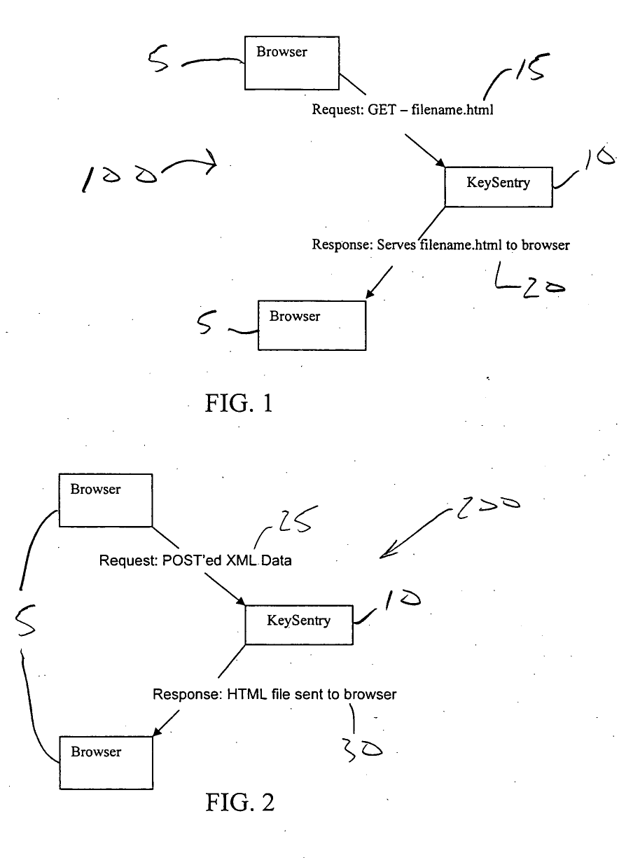

Turning now to FIG. 1, a flow diagram 100 of an embodiment of the present invention is depicted in which a server 10 receives a “GET” command, initiated by a user through a web browser 5. A GET request 15 is a means to pass an instruction from the browser 5 to the server 10 to retrieve a requested file. A request 15 is sent from the browser 5 to GET a data file. In this embodiment a file named “filename.html” is requested, however one skilled in the art should recognize that the scope of the present invention is not limited to the specific filenames used herein. The server 10 responds 20 to the GET request 15 by serving the requested file to the browser 5.

FIG. 2 depicts a POST instruction process 200 in accordance with an embodiment of the present invention. A POST instruction submits user data from a browser 5, to the server 10. The user data is included in the body of the request 25. Web pages that are POSTed to the server 10 have an XML component within the web page. The XML may have three primary components: a remote server session identifier, a command, and data to be processed. The user will initiate a request through the browser 5 to retrieve the POSTed XML data 25. The server 10, upon receiving the request 25 will extract the XML data and parse the data for recognizable commands. The server 10 will then call an application object corresponding to the command extracted from the XML data. The server 10 will then execute the command based upon the data submitted in the XML. The server 10 then creates a response 30 HTML page and sends the page to the browser 5. An example of an XML file POSTed to the server 10 is given below:

<KeySentry>

< RemoteServerSessionID >1234567</ RemoteServerSessionID >
<Command>EncryptAndSign</Command>
<Data>

<Database name=“Database Name”>

<Table name=“First Table Name”>

<Column id=“col1” size=“255” type=“char”>
12.33.45.66</Column>
.
.
.

</Table>
<Table name=“Second Table Name”>

<Column id=“col1” size=“255” type=“char”>
12.33.45.66</Column>
.
.
.

</Table>

</Database>

</Data>

</KeySentry>

The name “KeySentry” in the sample file above is used herein as merely a trade name for an embodiment of the inventive server 10. The name used in various embodiments described herein is arbitrary and should not be construed as a limitation of the present invention.

The commands extracted and parsed from the XML data may take various forms relating to the functionality of the server 10. These functionalities include, without limitation, certificate generation, authentication, remote application connectivity, document collaboration, software installation, and remote assistance. Each of the functionalities is described separately below. Commands relating to the generation of digital certificates include creating a certificate request and creating the certificate itself. Commands for user authentication include accepting a merchant's information, processing a merchant's authentication string, examining the merchant's response to a client, or user's authentication string, and responding to the merchant's certificate identifier with a revocation list if one exists and the merchant's certificate has been revoked for any reason.

For the remote application connectivity functions, the server can handle a transfer file in at least two ways. In circumstances where the local program generates a transfer file, the commands of the XML data can include encrypting the transfer file as well as encrypting and signing the transfer file. In a situation where the local program enables the user or client to create the transfer file himself, the commands include constructing the transfer file.

The commands in the server 10 for the functionality relating to document collaboration include a process update which responds by sending updates, if any exist, from the local computer. The software installation functionality includes commands to install the actual software and respond with the transmission of relevant information to the software supplier. The remote assistance capability uses commands that will gather diagnostic data as well as process instructions sent from the remote computer.

While the embodiments herein list a series of commands associated with the functionalities of the server 10, one skilled in the art should recognize that the above enumerated commands and functionalities are merely examples and other commands and functionalities may be implemented without deviating from the scope of the invention.

An embodiment of the present invention includes a security measure in which the server maintains an IP address of ‘127.0.0.1’ or ‘localhost’ and thus can only ever be accessed via a browser running on the same computer. Additionally, when a computer connects to the web it is given an IP address, either permanent or temporary. If a user attempts to connect to the program on this IP address rather than ‘127.0.0.1’ or ‘localhost’, then that connection is refused.

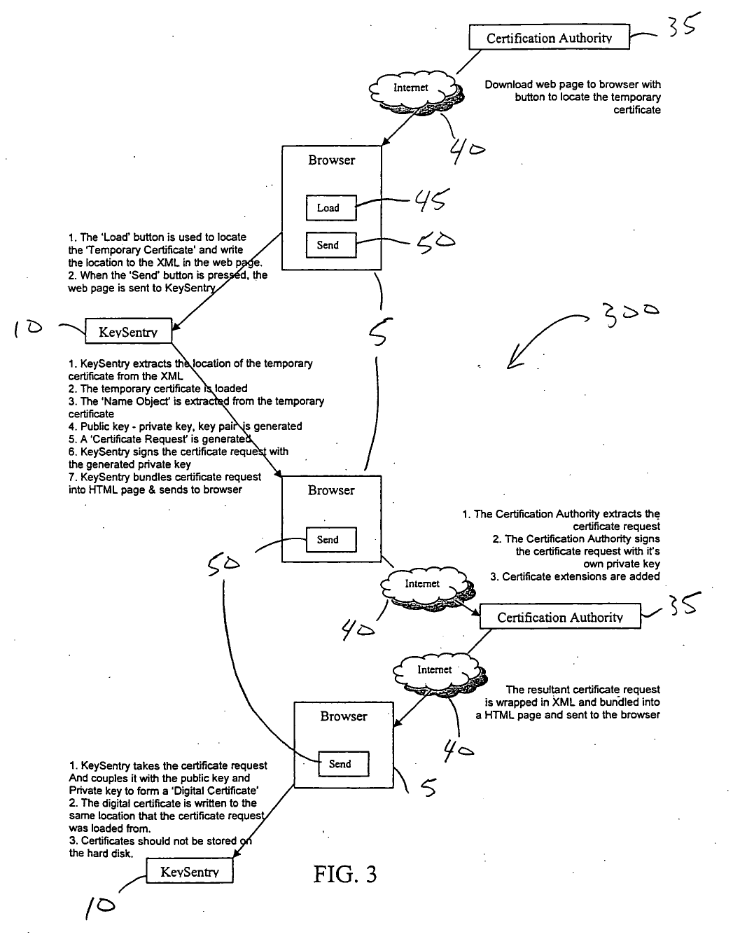

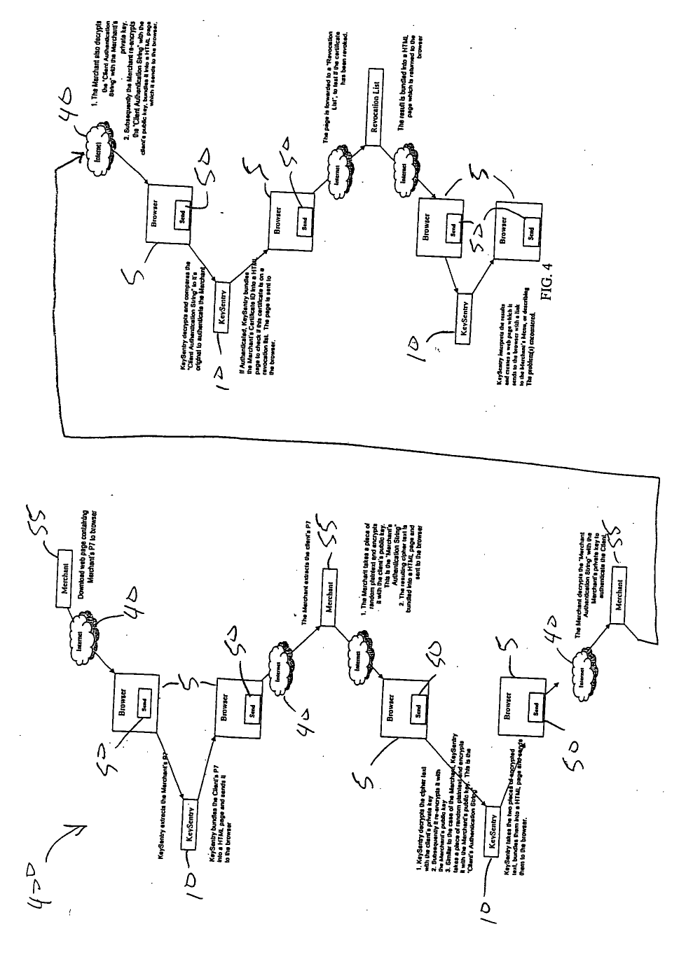

Turning now to FIG. 3, flow diagram 300 of an embodiment of the digital certificate generating process is depicted. A certification authority 35 is used to obtain a digital certificate to ensure a secure transaction. For example, a member of the public may visit a certification authority 35 and after presenting the required identification information, has a temporary digital certificate issued by a governing authority. The person may then connect to the certification authority 35 website over the internet 40 and download a web page to their browser 5, which allows them to locate a temporary digital certificate issued by the governing authority. The user may request the digital certificate by initiating a LOAD command 45. The Certification Authority 35 advises that the temporary digital certificate and the digital certificate which is about to be created are stored on a removable media such as a floppy disk, CD, DVD, Flash Memory Card or USB memory key. The user, by clicking the ‘Send’ button 50, issues a POST command sending the downloaded web page and its contents, in XML, to the server 10 rather than POSTing the web page back to the Certification Authority 35.

The server 10 then loads the temporary digital certificate. The purpose of the temporary digital certificate is to create a ‘verifiable’ Name Object, a very important component of a digital certificate. The Name Object is verifiable because the person to whom it was issued had to present identifying information to obtain the temporary digital certificate. The Name Object is extracted from the temporary digital certificate and the server 10 generates a public key/private key pair. The server 10 then creates a ‘Certificate Request’ and signs it with the newly generated private key. The Certificate Request is wrapped in XML and bundled into a non-functional web page which the server 10 then sends to the browser 5 through the internet 40. When the user clicks the ‘Send’ button 50 on the page issued by the server 10 to his or her browser 5, the page is sent to the Certification Authority 35, rather than back to the server 10.

The Certification Authority 35 extracts the Certificate Request and signs it with its own private key, thus creating a ‘Certificate Chain’. Other certificate extensions may also be added. Digital Certificates will have use when they are issued by an authority which is recognized and accepted by others, forming a certificate-chain. A digital certificate from one authority creates a chain of two certificates. The first authority's certificate would be first in the chain and a top authority, say the government in this example, certificate would be at the top of that chain. Thus when a merchant examines the public component of the digital certificate, they can see who issued the certificate. From the next certificate up in the certificate-chain, they can see who empowered the issuer to issue that certificate. Additionally, the merchant can view the certificate issuing policies of both the first authority and the government in order to satisfy themselves of the worthiness of the certificate they received. When certain extensions are added to a certificate it enables that certificate to be a “code-signing certificate”. This means that when a piece of software is signed by a digital certificate, then the origin of that software can be determined.

The enhanced Certificate Request is wrapped in XML and bundled into a non-functional web page which is returned to the user's browser 5 through the internet 40. Clicking the ‘Send’ button 50 sends the contents of the downloaded web page to the server 10. The server 10 then extracts the Certificate Request, couples the Certificate Request with the generated public key/private key pair to form a ‘Digital Certificate’. The ‘Digital Certificate’ is then written to a removable medium such as a floppy-disk, CD, DVD or USB memory key.

Turning now to FIG. 4, the authentication process 400 of an embodiment of the present invention is shown. A user or client downloads a web page containing a merchant's 55 information of a digital certificate to their browser 5. The client sends the downloaded web page over the internet 40 to the server 10 by clicking the ‘Send’ button 50. The server 10 stores the merchant's 50 information for the duration of the transaction and responds by sending a web page containing the client's information to the browser 5. By clicking the ‘Send’ button 50 in the web page in the browser 5, the client sends their own information to the merchant 55 back through the internet 40. On receipt of the client's public information, the merchant 55 extracts the client's public key and encrypts a random plaintext message using the client's public key. The resulting cipher text is bundled into a web page and sent to the client's browser 5. The client sends the downloaded web page containing the cipher text to the server 10 by clicking the ‘Send’ button 50.

When the server 10 receives the cipher text, it uses the client's private key to decrypt the cipher text to plaintext and then takes a random piece of plaintext and encrypts it with the merchant's 55 public key. It also takes the plaintext message from the merchant 55, described above, and re-encrypts it with the merchant's 55 public key. The server 10, in this embodiment, takes the two pieces of cipher text, bundles them into a non-functional web page and sends the web page to the browser 5. By clicking the ‘Send’ button 50 in the web page in the browser 5, the client sends both pieces of cipher text to the merchant 55. The merchant 55 takes the piece of cipher text message and decrypts it with the merchant's 55 private key and compares it to the piece of random plaintext it used to authenticate the client. If they are the same, the client is authenticated. Similarly the merchant 55 takes the second cipher text and decrypts it with its private key. Subsequently, the merchant 55 encrypts the plain text with the client's public key, bundles it into a web page and sends the web page to the client's browser 5. By clicking the ‘Send’ button 50 in the web page, the client sends the cipher text to the server 10.

The server 10 decrypts the received cipher text using their private key and compares it with the random text from the second cipher message described above. If they are the same, the merchant 55 is authenticated. If the merchant 55 is authenticated, the server 10 takes a merchant's certificate identifier, bundles it into a non-functional web page and sends it to the browser 5. By clicking the “Send” button 50 in the web page in the browser 5, the client sends the merchant's certificate identifier to a revocation list to determine if the merchant's certificate has been revoked. The revocation list bundles the ‘Yes/No’ answer into a non-functional web page which it sends the client's browser 5. By clicking the ‘Send’ button 50 in the web page, the client sends the response to server 10.

If the merchant 55 was authenticated and their certificate is not on a revocation list, the server 10 creates a non-functional web page with a link to the merchant's menu and sends that web page to the browser 5.

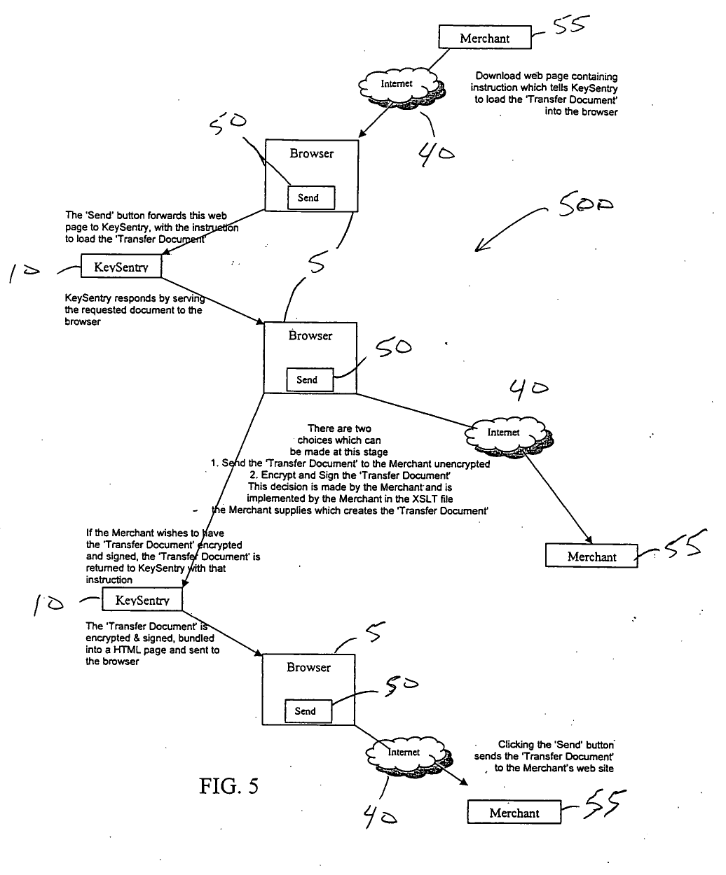

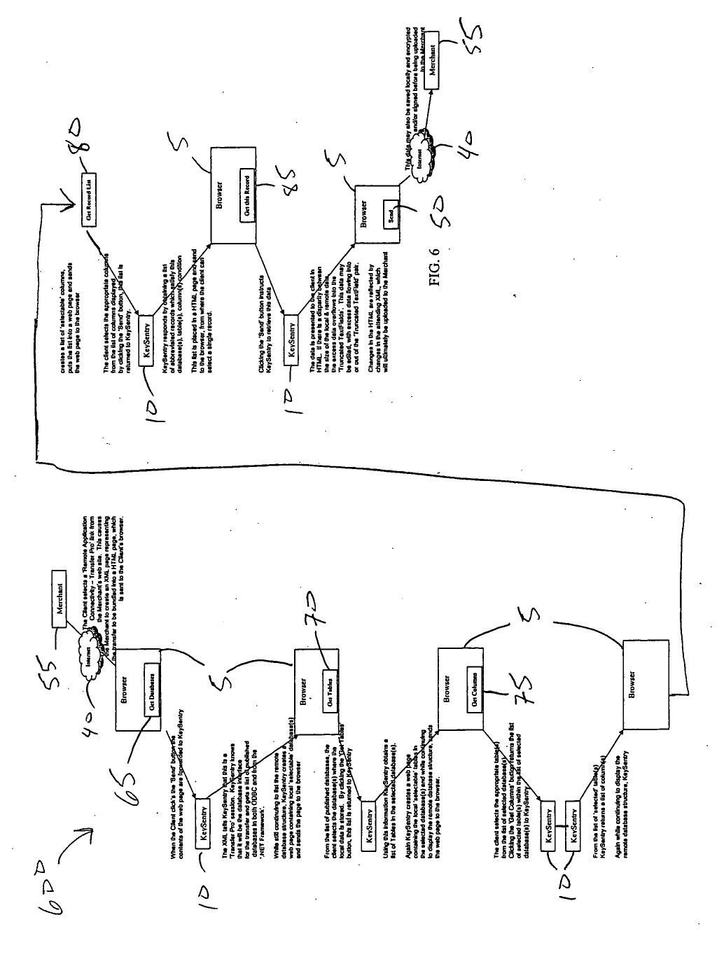

FIG. 5 shows an embodiment of a remote application connectivity process 500 in which the transfer file has already been created by the computer program requesting a remote connection to the merchant's website 55. In this embodiment, such a process is referred to as a “Transfer Lite” session. The name “Transfer Lite” is an arbitrary term used for reference herein and should not be construed by one skilled in the art as a limitation to the inventive application.

By selecting the appropriate link on the merchant's 55 web site, a web page is downloaded to the browser 5 containing an instruction which tells the server 10 that this is a “Transfer lite” session. By clicking the “Send” button 50, this web page and its contents are sent to the server 10. The server 10 retrieves the web page from a “Transfer lite” directory. This web page and its corresponding XML document are created by the local program wishing to connect. In this embodiment, one HTML document and its attending XML document exist in the “Transfer lite” directory. The documents are deleted by server 10 after the session has finished. The HTML document is constructed from an XML document, produced by the local program, and from instructions in an extensible style-sheet language transformation (“XSLT”) document, provided by the merchant 55. If the merchant 55 wants to receive an encrypted and signed document, then the instruction required is contained in the XSLT document. Depending on the wishes of the merchant 55, pressing the “Send” button 50 either sends the document to the merchant 55 in plaintext or the document is returned to the server 10 where the document is signed and encrypted. After it is signed and encrypted, the document is returned from the server 10 to the browser 5. Clicking the “Send” button 50 then sends the document to the merchant 55.

FIG. 6 depicts another embodiment of the remote application connectivity process 600 in accordance with the present invention. In this embodiment, referred herein as the “Transfer Pro session,” a process in which the local program wishing to connect to the remote application does not have the ability to create a transfer document. In this embodiment it is assumed that the local application has the ability to store records in a local database. The process of connecting remote programs involves the connecting of the corresponding databases of the two programs. Two databases, whether local or remote, will connect providing there is agreement on three issues: the number of columns of the connecting database being less than or equal to the number of columns in the database which is being connected to; the data-types of the columns of the connecting database being the same or compatible with the data-types of the columns of the database being connected to; and the size of the connecting databases columns being less than or equal to the size of the columns of the database being connected to.

The process 600 resolves the three issues above by having the server 10 create an XML representation of the local database(s), receiving an XML representation of the database(s) being connected to and ultimately reconciling differences between the two. In many cases, disparities between the local database(s) and the remote database(s) may actually be irresolvable, i.e. the size of local column is greater than the corresponding remote column. Attempting to upload data in such cases would lead to structured query language (“SQL”) exceptions and the transfer would be blocked. The server 10 resolves this issue through the use of “Truncated TextFields”. Truncated TextFields are HTML graphical components where the data which is greater than that which can be received by the database being connected to is allowed to overflow into a companion TextField. Truncated TextFields are a pair of TextFields which work in tandem, having particular editing capabilities, and replace the single TextField which would normally represent the content of the local column.

A certain level of knowledge is required in assisting the server 10 to identify database(s), table(s) and column(s) which will make up the transfer. One skilled in the art should recognize that the job of reconciling local and remote databases is simplified by the fact that the program which created and feeds database(s), table(s) and column(s) will by its nature be similar in structure and content to the remote database(s), table(s) and column(s) to which it is attempting to connect.

When a client selects a “Transfer pro” link on a merchant's web site, it causes the merchant 55 to create an XML document representing the transfer to be bundled into a non-functional web page and downloaded to the client's browser 5. Clicking the “Get Databases” button 65 on the downloaded web page, causes the page and its contents to be sent to the server 10. An instruction in the XML document informs the server 10 that this is a “Transfer pro” session. The server 10 responds by querying the ODBC (Open Database Connectivity) and the .NET Framework to find which databases are present locally, with accessible data. The server 10 creates a list of accessible databases, puts the list in a HTML page and sends the page back to the client's browser 5. A tick-box beside each database allows the client to select the database where it is believed the required data exists. Clicking a “Get Table(s)” button 70, sends this page back to the server 10 which gets the table(s) for these database(s). The server 10 puts the list of table(s) into a non-functional HTML page which it sends back to the client's browser 5. The client ticks the appropriate table(s) in the list. Clicking the “Get Columns” button 75 sends the web page back to the server 10. The server 10 gets the column(s) for each of the table(s), puts them in a selectable list in a non-functional HTML page and sends the page back to the browser 5.

While the selection process is on-going, the remote database structure continues to be displayed in order to assist the client to make a proper selection of database(s), table(s) and column(s). The client selects the appropriate columns. Clicking the “Get Record List” 80 causes the page to be returned to the server 10. The server 10 now compares the “database(s), table(s), column(s)” selection against the XML document it received from the merchant 55. If there is a difference between the number of columns the client has selected and the number of columns which the merchant 55 wants filled, the server 10 informs the user so that changes need to be made. When the number of columns is resolved, the server 10 creates its own XML file representing the selection. The server 10 takes the newly created XML file and reconciles it against the merchant supplied XML file for the purpose of deciding if Truncated TextFields need to be employed. A transfer XML file is created and saved by the server 10 in a directory of the merchant's 55 name so that the process just completed will not need to be repeated.

The processing above is invisible to the client. The client sees simply an abbreviated list of records which the server 10 puts in a HTML page and sends to the browser 5. The client selects one of the records. Clicking the “Get this Record” button 85 sends the HTML page back to the server 10. The server 10 retrieves the record and creates a HTML page containing the data. This page is created using the XML transfer file developed and described above. If it is determined that Truncated TextFields need to be employed, the server 10 places these in the appropriate place. The resulting HTML file is sent to the browser 5, with Truncated TextFields where appropriate, so that the client can edit the data being transferred if necessary. The transfer may be signed or encrypted by being returned to the server 10, if necessary, alternatively it may be sent to the merchant 55 in plaintext form.

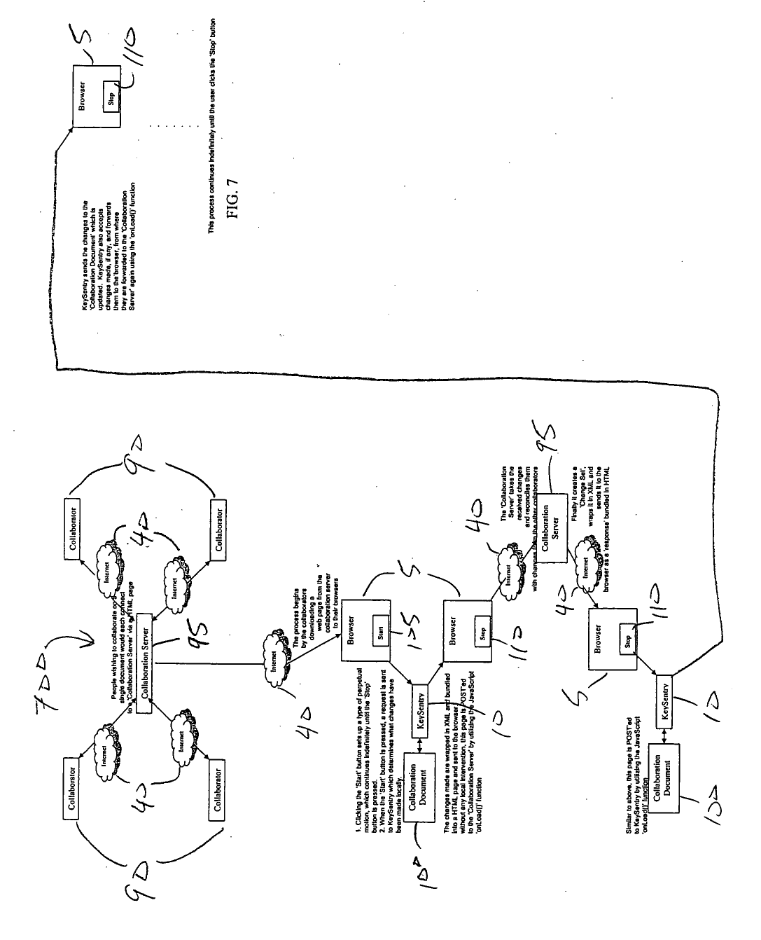

Turning now to FIG. 7, a document collaboration process 700 in accordance with an embodiment of the present invention is shown. People or collaborators 90 wishing to collaborate on a single document 100 would each connect to a collaboration server 90 via an HTML page. A template document 100 is created and uploaded to the collaboration server 95. Subsequently, each of the collaborators 90 requests the template document over the internet 40 from the collaboration server 95 and saves it to their own computer. Each collaborator 90 may then open and edit the document 100 on which they wish to collaborate.

The collaborator 90 clicks the “Start” button 105 to begin a process in which a request is sent to the server 10 to determine what changes have been made locally. When any collaborator 90 makes a change, that change is wrapped in XML and sent to the server 10. The server 10 then POSTs the changes, using the “onLoad( )” function from JavaScript, to the collaboration server 95, via the browser 5. Each of the other collaborators 90 receives the changes passively at intervals set by the collaborators 90 as the refresh rate. The collaboration server 95 takes the received changes and reconciles them with other changes from the other collaborators 90. The collaboration server 95 then wraps the changes in XML and sends a response bundled in HTML as a non-functional web page to the browser 5. The process can continue indefinitely until the collaborator 90 presses the “Stop” button 110 and changes are no longer tracked by the server 10. All the benefits of PKI described above, like authentication, encryption and document signing, may also be implemented with the document collaboration process 700.

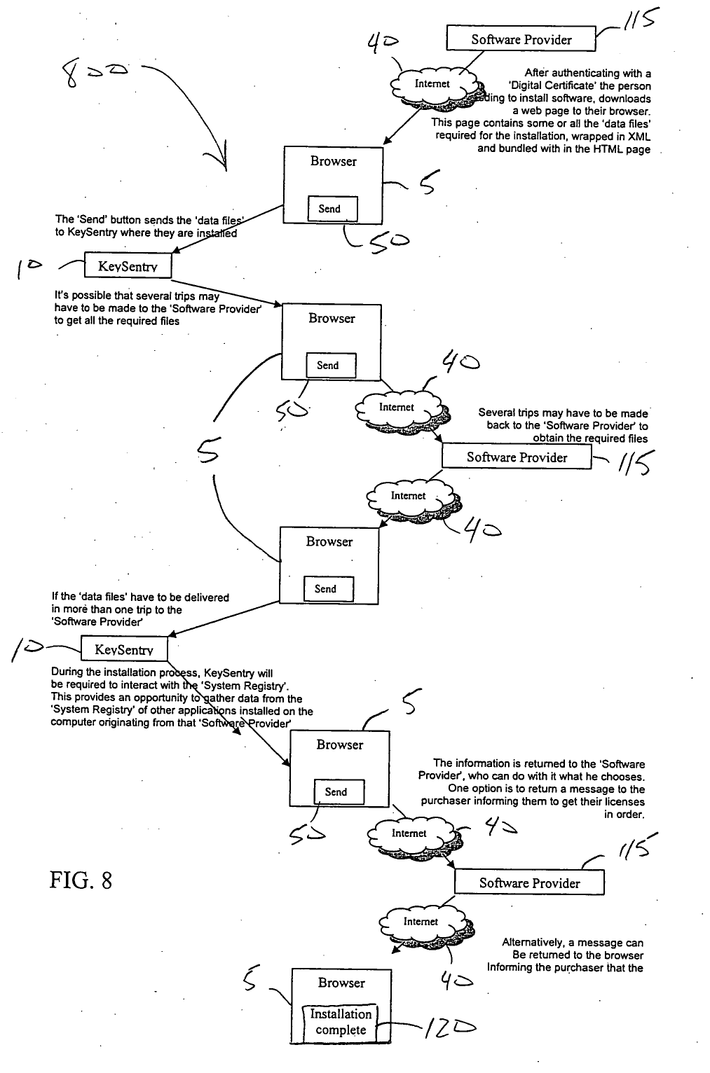

Turning now to FIG. 8, a software installation process 800 in accordance with an embodiment of the present invention is shown. Traditionally software is installed by downloading an executable file. The problem for software providers is that the downloaded executable can be copied to any number of computers, for which the license does not apply. The present invention provides a server 10 in which the software to be installed is delivered after authenticating with a “Digital Certificate”. The executable is not downloaded, rather the required data files are downloaded and the functionality is provided by the server 10. At the conclusion of the installation, the downloaded data files are deleted by server 10. The user wishing to install software connects to the software provider 115 website. After the user selects to install a software package, an “Authentication” page is downloaded to the user's website. The authentication page may contain some or all of the data files required for installation XML bundled into the non-functional HTML page. The user must then authenticate using the application by entering the authentication data into the browser 5 and clicking the “Send” button 50. Once the user has been authenticated, the software provider 115 takes the transaction server files and encrypts them, before adding the encrypted transaction server files to an archive file, i.e. a CAB file (this is a MicroSoft® term for a “cabinet” file which is generally an archive file). This CAB file is downloaded to the user's computer. Once the CAB file is fully downloaded, the user is required to signify to the server 10 that the CAB file is ready to be installed. The server 10 takes the CAB file and extracts the transaction server files and decrypts them using a purchaser's authentication data, typically a private key. The server 10 then uses these transaction server files to install the software. The final step in the process in this embodiment is for the server 10 to take the Registry entries relating to the software provider 115 and pass them back to the software provider 115, where the software provider 115 may use the installation information in any number of ways. After the installation data is transmitted to the software provider 115 over the internet 40, an “Installation Complete” message 120 is sent to the user's browser 5 terminating the process.

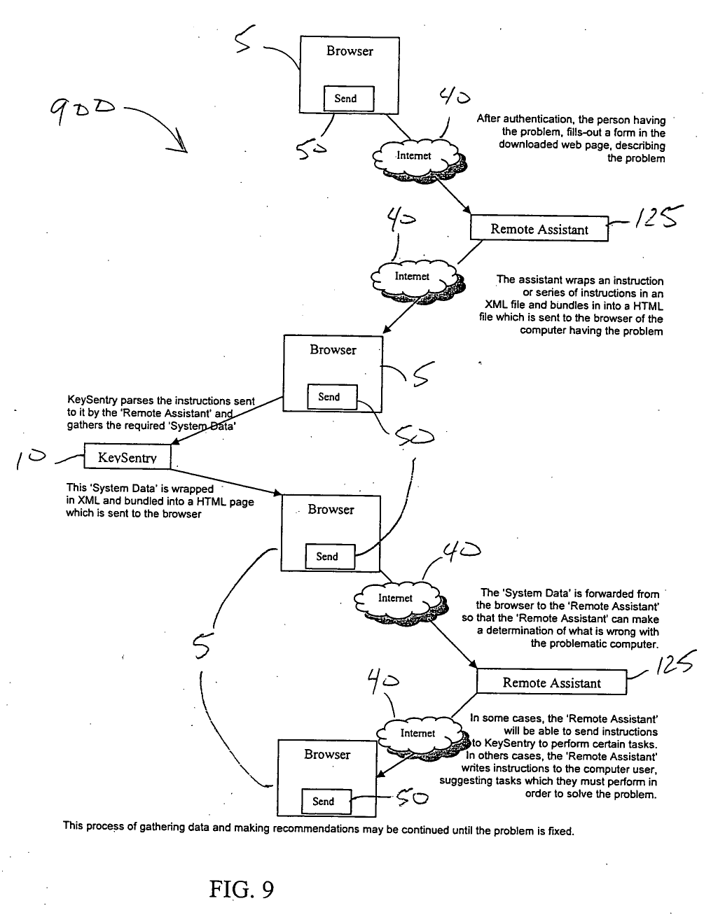

Turning now to FIG. 9, a remote assistance process 900 in accordance with an embodiment of the present invention is shown. It is typically a requirement that any remote assistance session be authenticated. It is vital to the security of all parties involved to establish the identity of the remote assistant and to avail the user of the signing capabilities of PKI, which create a verifiable audit trail for both parties. This ensures any parties giving instructions or information can be tracked and held accountable.

A user who wishes to seek remote assistance, connects through a browser 5 over the internet 40 to a website of a company which provides remote assistance 125. The user is required to authenticate with the remote assistance website and the remote assistant 125 is required to authenticate with the user. Once authentication is completed by both parties, the user is required to complete a form describing the problem the user is experiencing. The remote assistant 125 sends a series of instructions in an XML file bundled in to a non-functional HTML file to the browser 5 on the user's computer. The user then, by clicking the “Send” button 50 passes the instructions on to the server 10 where it is parsed. The parsing process includes determining from which areas of the user's computer data needs to be gathered. This system data is gathered into an XML file which may or may not be encrypted, but which is digitally signed and sent back to the user's browser 5. The system data may be sent from the user's browser back to the remote assistant 125 so that the remote assistant may diagnose the computer's problems. As the remote assistance session progresses, the user may be required to gather more data, which again is gathered into another XML file, which is also signed before being uploaded to the remote assistant 125. The remote assistant 125 determines what problem the user's computer is suffering from before making suggestions about how the computer may be fixed. The remote assistant 125 may, in some embodiments, be able to send instructions directly to the server 10 to perform certain tasks. In other embodiments the remote assistant 125 will write instructions to the user's browser 5 suggesting tasks for the user to complete to resolve the computer's problem. The overriding purpose of signing the XML files, which are stored on the user's computer and the remote assistant's 125 computer, is to be able to create an audit trail, so that those people responsible for giving bad advice or information may be held accountable. One of the advantages of this system over existing ones is that it is non-invasive. The remote assistant 125 is not allowed to explore the entirety of user's computer and discover sensitive or protected information. Instead it is the user who navigates the system, with the help of the server 10 and the instructions from the remote assistant 125.

Although the embodiments described herein mention specific protocols, e.g., HTML or XML, and particular “buttons” are mentioned, e.g., SEND or Get Databases, it should be appreciated that other protocols and/or buttons could be implemented having substantially the same functionality according to the invention.

Although the invention is described herein implemented in the context of a client-server implementation with the connectivity server on the client side, it should be appreciated that secure connectivity could be implemented according to the invention in other configurations. Similarly, although web sites are generally described as the mechanism for interfacing to the inventive aspects and a web page is used as the “non-functional” element, it should be appreciated that alternative implementations, interfaces and elements could be configured according to the invention.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed:

1. A method for secure connectivity in a network, comprising the steps of:
making a request for authentication relating to a first site;
receiving a unique identifier from the first site;
sending a non-functional package with a unique identifier to the second site.

2. The method of claim 1, further comprising creating the non-functional package from data received from the first site.

3. The method of claim 1, wherein the non-functional package is a web page.

4. The method of claim 1, wherein the non-functional package includes a digital certificate.

5. The method of claim 1, wherein the non-functional package is an XML file bundled with an HTML web page.

6. The method of claim 1, wherein the non-functional package is encrypted.

7. The method of claim 1, wherein the non-functional package details a set of changes related to a collaborative document.

8. The method of claim 1 wherein the non-functional package contains data files for the installation of a third program.

9. The method of claim 1 wherein the non-functional package contains a set of instructions for resolving a computer problem.

10. A method for securely connecting remote programs in a network comprising:
receiving a request for connecting a first program to a second program; and
sending a transfer document to the second program, the transfer document containing a set of instructions for interfacing the first program to the second program.

11. The method of claim 10 wherein the transfer document is an XML file bundled with an HTML web page.

12. The method of claim 10, further comprising creating the transfer document, the transfer document resolving data incompatibilities between the first program and the second program.

13. The method of claim 10 wherein the data incompatibilities reside in non-matching database forms.

14. A system for securely connecting computer programs comprising:
a web interface;
at least one command;
a non-functional package containing the at least one command and a unique identifier; and
a server application, the server application forwarding the non-functional package from a first site to a second site, the second site parsing the non-functional package and executing the at least one command.

15. The system of claim 14, wherein the first site and the second site reside on different computers.

16. The system of claim 14, wherein the non-functional package is a digital certificate.

17. The system of claim 14, wherein the non-functional package is encrypted.

18. The system of claim 14, wherein the non-functional package details a set of changes related to a collaborative document.

19. The system of claim 14 wherein the non-functional package contains data files for the installation of a program.

20. The system of claim 14 wherein the non-functional package contains a set of instructions for resolving a computer problem.
